(19) United States
(12) Patent Application Publication
(10) Pub. No.: US 2017/0190984 A1
(43) Pub. Date: Jul. 6, 2017

(54) A METHOD OF CRACKING AND/OR DEMULSIFICATION OF HYDROCARBONS AND/OR FATTY ACIDS IN EMULSIONS

(71) Applicant: GALEXUM TECHNOLOGIES AG, Cham (CH)

(72) Inventors: Karel KOHLIK, Campione d'ltalie (IT); Karel KOHLIK, Mellingen (CH); James Michael HALEK, Roanoke, TX (US)

(21) Appl. No.: 15/127,798

(22) PCT Filed: Mar. 20, 2015
(86) PCT No.: PCT/IB2015/000570

§ 371 Date: Sep. 21, 2016

(30) Foreign Application Priority Data
Mar. 21, 2014 (CZ) PV 2014-170

(51) Int. Cl. C10G 33/02; E21B 43/24; E21B 43/38; C10G 15/08; B01D 17/04

(52) U.S. Cl. CPC C10G 33/02; C10G 15/08; B01D 17/04; E21B 43/38; E21B 43/24

(57) ABSTRACT

The invention relates generally to a method for cracking and/or demulsification of hydrocarbons and/or fatty acids in emulsions, wherein these hydrocarbons and/or fatty acids in emulsions are exposed to an electromagnetic field created by a microwave emitting process, whereas this electromagnetic field is correlated with the oscillation frequency of the longer chained molecules of these hydrocarbons and/or fatty acids, by either adapting the exact correlated frequency and/or by adjusting the electromagnetic field to the properties of the targeted hydrocarbon and/or fatty acid molecules and its emulsions by adding suitable catalysts and by applying the correlated microwave output power.

### TECHNICAL FIELD

The invention generally relates to a method for lowering the gravity and viscosity of crude oil by cracking longer chained hydrocarbon molecules into shorter chained hydrocarbon molecules and to the simultaneous or to an independent demulsification of hydrocarbon emulsions by means of microwave radiation, primarily on a non-thermal and/or low-energy basis.

The invention furthermore relates equally to the method for cracking fatty acid molecules (CxHyCOOH—bonds), if desirable, and the simultaneous or to an independent demulsification of (a) fatty acid emulsion (emulsions) by means of microwave radiation, primarily on a non-thermal and/or low-energy basis.

### PRIOR ART

From the prior art, compared with the present invention, a close document is published under U.S. patent application US 2011/0128203 A1 (published on Jun. 2, 2011, authors James Michael Halek et al), disclosing an apparatus producing microwaves for the purpose of demulsification of hydrocarbon emulsions. This patent application US 2011/0128203 A1, however, only discloses the basic construction and design of one potential apparatus to be used for this purpose (out of several other possible apparatuses) and is not relating in any way to the method in accordance with the invention as describe herein. Several further filed patents (see only US 2004/0031731 A1, US 2006/0251557A1, US2007/0017876A1, US2010/0111780A1, US2013/0026082A1) are dealing also with either microwave-based bond cracking methods and/or with a demulsification method. However, all these patents are using microwaves in terms of a pure heating source or in frequency ranges that point to a medium- to high energy or thermal approach. The invention as described herein, is focusing on lower frequencies with low-energy effects and whereas a dedicated pre-defined electromagnetic field is being created, not leading to a considerable heating effect, thus always staying below the water boiling point as to all treated emulsions.

### Basic Information Concerning a Hydrocarbon Emulsion

An emulsion is an immiscible liquid (dispersed phase) dispersed in another liquid (continuous phases). Three classes of emulsions are generally distinguished: oil-in-water (O/W), water-in-oil (W/O) and complex (multiple) emulsions. Multiple emulsions have droplets of the continual phase inside the droplets of the dispersed phase as emulsions of the water-in-oil-in-water (W/O/W) type. In these emulsions the so-called “substrate” is particularly undesirable, but is typically present in many industrial areas such as crude oil exploration, pumping, pipelines, transportation, refineries etc. The substrate, containing for instance as to crude oil potentially: water, metal particles, sand, sulfur, coke, paraffin, waxes etc. forms therefore the part of the emulsion that should be preferably separated, thus leading to a cleaner emulsion of higher quality hydrocarbons with less impurities at very high efficiency in combination with the desired simultaneous cracking effect of the longer chained hydrocarbon molecules.

Thus, the object of this invention is a method for cracking and/or demulsification of hydrocarbons and/or fatty acids in (an) emulsions(s) and their separation from undesired impurities in an efficient manner; in the field of petroleum exploration or petroleum refinery processes this method relates to the cracking of hydrocarbons with longer chains into hydrocarbons with shorter chains, and to the separation of hydrocarbons from water, sulfur, sand, metallic particles and other impurities; and the method further relates to the here described procedure also leading under the in this patent writ described circumstances into a further desired drop out of a large percentage of paraffin, waxes and/or coke, whereas this process can be also optimized by using suitable catalysts, depending on the emulsion to be treated.

Hydrocarbon emulsions, such as medium-heavy to heavy crude oil, are typically water in crude oil emulsions (W/O), which are usually quite stable. Apart from indigenous natural surfactants contained in the crude oil, asphaltenes and resins are also crucial as to the formation and stability of W/O emulsions. These hydrocarbon emulsions can be either found in an oil reservoir (underground media) or in storage tanks, pipelines or vessels (oil tankers) on surface, before they are processed in different components.

Based on the here before described emulsion types the patent application herein distinguishes and used the terms solid emulsion and liquid emulsion.

Description of the Method in Accordance with the Invention Leading to Cracking of Hydrocarbon Chains in an Emulsion and an Efficient Demulsification Process

This invention provides for a method to process W/O, O/W or W/O/W emulsions to efficiently demulsify them and thus to majorly isolate the hydrocarbon liquid from the undesired components and to simultaneously break the longer-chained hydrocarbons into shorter-chained hydrocarbons and thus changing the viscosity and API-gravity of the isolated hydrocarbon liquid on a permanent basis, by applying a certain microwave emitting procedure as described in this patent application. This emitting procedure can be either applied in-situ (for underground hydrocarbon reservoirs) or on surface (in tanks or in dedicated flow-through designs).

The subject matter of the invention is that microwaves are not used primarily for the initiating and maintaining of a heating process but for the accurate influencing of the natural oscillation of the hydrocarbon molecules, potentially by using suitable catalysts, to achieve a potentiation by causing the directly or indirectly through suitable catalysts influenced hydrocarbon molecules to affect the oscillation of the neighboring hydrocarbon molecules (“molecular resonance effect”). This potentiation leads, subject to the proper microwave frequency and power emission, potentially combined with a pulsing treatment, to the described permanent change in viscosity and API-gravity of the hydrocarbons and to the efficient demulsification of such emulsion.

Description of the Method in Accordance with the Invention Leading to a Cracking of the Fatty Acid Chains in the Emulsion and an Efficient Demulsification Process for these Emulsions, Potentially with a Succeeding Organic Synthesis of the Demulsified Product

The invention as described here before regarding the hydrocarbon emulsions can be equally applied on the cracking of longer chained fatty acid molecules into shorter chained fatty acid molecules and especially also on the efficient demulsification of fatty acid emulsions, thus enabling the fatty acids to separate more easily from the undesired substrate, which occurs more efficient by using selective catalysts, such as water for instance. Furthermore, the ppm-ratio of certain non-desired products (e.g. phosphor content in rapeseed oil) are being lowered substantially in the demulsification process of the fatty acid emulsion.

Suitable catalysts that are being added to the emulsion or the separated demulsified main product, as described further below, enable furthermore a desired re-arrangement of the separated fatty acids, leading to a desired synthesis product (e.g. prior demulsification of fatty acid emulsions out of vegetable or animal oils/fats by use of microwaves and succeeding reaction under the influence of microwaves by using the demulsified fatty acids+methanol (+sodium-methoxide NaOCH3 if only a low amount of free fatty acid bonds are present) to achieve as main product fatty acid methyl ester (FAME)).

### SUMMARY OF THE INVENTION

The present invention describes a unique process in order to achieve a cold cracking of hydrocarbon or fatty acid molecular bonds and also to achieve a higher and more efficient demulsification success rate by using specific microwave emitting and efficiency enhancement procedures, namely cracking and demulsification catalysts. As to the fatty acid emulsions, the microwave process as described herein may furthermore be used, by adding specific catalysts, in order to reach a high efficient-low energy organic synthesis for esterification purposes, thus producing fatty acid methyl ester (FAME) as a main product out of fatty acid emulsions (even out of un-pretreated waste kitchen fat/waste cooking oil).

All the here before described processes (cold cracking (hydrocarbon and fatty acid emulsions)-demulsification (hydrocarbon and fatty acid emulsions)-synthesis (only fatty acid emulsions) are based on the main invention in this patent writ as a method by exposing the hydrocarbon and/or fatty acid emulsions to a pre-defined electromagnetic field, that targets the oscillation frequency of the hydrocarbon bonds and/or fatty acid bonds, by correlating and defining the applied microwave frequency and the power output of the microwaves during the exposure to the emulsion, to the specific oscillation frequency of the targeted hydrocarbon and/or fatty acid bonds.

The emulsions to be used preferably subject to the here described cracking, preferably cold-cracking and demulsification method are of the type water-in-oil (W/O), oil-in-water (O/W) or water-in-oil-in-water (W/O/W) emulsions.

Depending whether hydrocarbon emulsions are targeted in a formation below surface or whether hydrocarbon- and fatty acid-emulsions are targeted on surface in treatment tanks or in flow through processes, the approach and method differs slightly.

Nevertheless, the following methods in accordance with the invention shall be carried out. Ahead of the determination of the appropriate treatment with microwaves as to frequency and power output and a possible alternating pulsing procedure, the molecular frequency of the hydrocarbon- or fatty-acid-chains to be cracked shall be determined with the appropriate measurement device (e.g. oscilloscope, radio spectrometry, etc.) or can be calculated depending on the existing longer chained bonds. An approximation/range is suitable, as the method described herein has a broadband effect: The cracking effect is a function of applied frequency and applied power output, applied time and potentially a function of the used catalyst. The demulsification process by itself is less sensitive as to the described parameters here before, but the more precise the parameters are also correlated with the oscillation frequency of the targeted hydrocarbon or fatty acid bonds, the higher is the demulsification efficiency.

### BRIEF DESCRIPTION OF DRAWINGS

FIG. 1—is a design of an oil tanker in cross-section

FIG. 2—is a schematic drawing of the flow-through process with super heavy oil (not flowing)

FIG. 3—is a schematic drawing of the flow-through process with heavy to semi-heavy oil (flowing)

FIG. 4—is a microwave flow-through design

### EXAMPLES

### A) Cracking and Demulsification of Hydrocarbon Emulsions in a Formation (Pay Zone) Below Surface

In order to start or enhance the production of hydrocarbons in a formation from heavy to semi-heavy crude oil emulsions, first a suitable standard radio frequency emitter antenna (RFEA) shall be lowered into the wellbore to enable the emitting of the suitable frequencies into the payzone. In order to enable the cold cracking process of the hydrocarbons in the formation, an open hole design of the wellbore or a dielectric casing shall be used. If a metal casing is being used, the microwaves cannot be distributed in an efficient way into the payzone.

The RFEA shall be connected to a suitable surface microwave generator with a standard 915 MHz magnetron (or with a standard 896 MHz and 922 MHz), or with a frequency modulation system between 400 MHz and 2.5 GHz, at 100 kW, with a variable power output microwave generator adjustable between 10 kW output and 100 kW output power. A suitable RFEA could be for instance the one as set out in US-Patent Application No. US2011/0128203, James Michael Halek et. al. But other designs are also suitable or to be preferred, as long as a homogenous emitting of the microwaves is ensured. For in-situ hydrocarbon cracking and demulsification purposes the RFEA shall be preferably protected in the wellbore by a strong shield that should be made out of nano-ceramic or a ceramic-oxide-nano-ceramic compound, or out of teflon.

For in-situ cracking of hydrocarbons and demulsification purposes, the RFEA antenna should be preferably protected in the well with a strong shield that should be made of a microceramic compound or of glass ceramics reinforced with nanoceramic fibre.

Apart from other microwave emitting technologies in the wellbore that try to start or enhance heavy crude and medium-heavy crude hydrocarbon production out of a payzone by applying a heating effect, the patent as described in this patent writ enables and provides for a solution to change the API-gravity and viscosity of the heavy and semi-heavy crude emulsion in the payzone on a permanent basis by focus mainly on the non-thermal effect of the microwave field. This leads to a better in-situ flow process of the hydrocarbon emulsion and therefore to a higher production rate or to an ability to produce heavy crude or semi-heavy crude where there was no inflow before applying this technology. As a further “side-effect”, the hydrocarbon emulsion is being demulsified in the formation and thus separated to a large part from impurities, such as sand, metal particles, sulfur, water, etc. The quality of the produced crude oil is therefore also being improved and can therefore also be sold at higher prices at the refinery. In order to reach even better results, the cold cracking and demulsification method can be used again on surface in suitable treatment tanks, as described furthermore here below.

Compared to the here before described methods of the prior art, the energy consumption of the cracking and demulsification method as set out in this invention is 3 to 4 times lower and for the execution of this in-situ method no additional chemical admixtures are necessary. However, a certain water content in the payzone combined with an appropriate porosity above 15% is to be chosen preferably for this method, as water is acting as a catalyst for the cold cracking and demulsification effect due to its bipolar structure, opposite to the molecular structure of the hydrocarbon bonds. Water is here acting as a catalyst, whereas heavy oil surfactants can be further added ahead of applying the microwave treatment to act as further catalyst.

In the wellbore, the frequency of the microwave generator and thus the emitting waves of the RFEA shall be correlated and matched with the ex ante determined oscillation frequency of the longer chained hydrocarbon molecules as present in the targeted formation. This correlated frequency (determined as a function of the specific microwave generator frequency and the applied output power over time), causes the targeted molecules to enter into the necessary and desired resonance frequency. At this frequency, even small periodic force or energy impacts can produce large amplitude oscillations, because the targeted molecular system stores vibrational energy. The microwave generator output power needed will usually be approximately between 70-100 kW in-situ in the startup phase, but depending on the geological formation where the emulsion is located, lower power over a longer period of time might lead to better cold cracking results. Shorter hydrocarbon chains require more power output to reach the cracking and demulsification process.

At first, ideally the right frequency shall be chosen according to the pre-determined own oscillation wave curve of the long chained hydrocarbons to be targeted in-situ and the microwaves shall be emitted at a power output of up to 70-100 kW for a minimum of 2-3 weeks. However, depending on the water content of the formation and the porosity, the power output might be adjusted, depending on the chosen frequency, to as low as only 10-15 kW for this initial 2-3 weeks period. During this initial treatment process, the microwaves shall be emitted steadily over a period of 21-22 hours, the system shall be put on hold for 2-3 hours, before again switching the emitting on for another period of 21-22 hours. This switch-on/switch-off procedure shall be maintained all the time.

After 2-3 weeks, due to the change in API-gravity and viscosity of the hydrocarbons in the in-situ emulsion, the crude oil starts to flow towards the production tubing and starts to behave similar like semi-heavy or light crude oil, depending on the initial API-gravity and viscosity in-situ, and the porosity and permeability of the formation at hand. Once the crude oil starts flowing into the production tubing, the power level of the magnetron shall be tuned lower and the frequency might have to be adapted slightly based on the reached cold cracking efficiency and viscosity lowering effect rate. Once the crude oil is being extracted, the output level shall be adapted as low as possible in order to maintain the cold cracking and viscosity lowering effect at low energy rates.

This crude oil is, if processed according to this patent, already upgraded on a permanent basis, thus coming out in shorter hydrocarbon chains and already separated to a certain extent from the undesired substrate with impurities. The needed power amount is considerably lower than if microwaves had been applied based on a pure thermal approach. Nevertheless, the efficiency of the procedure as described in this patent is energetically higher. The resonance effect caused by the proper microwave frequency and/or by the adjusted microwave field by using magnetrons, with alternating between switch-on/switch-off and by lowering the power output over time enables the non-thermal procedure and thus a cold-cracking effect.

To maintain the production of the in-situ upgrading hydrocarbon emulsion, the microwaves shall be continuously emitted according to the procedure as described here before. A shutdown of the microwave emitting procedure for a longer time than 2-3 hours is of disadvantage only.

Effectuated Application:

In Montana, USA, a test has been undertaken in order to extract hydrocarbons from heavy oil formations using a microwave emitter system as described here before, applied on a heavy oil field, open completion well. The well has been prepared for 7″ casing but is has been left at open hole, not cased. Therefore no perforations were applied. The targeted payzone starts at 645 feet and goes down to 715 feet. Core analysis indicated 43 feet of excellent to fair oil saturated porosity. Core descriptions showed oil saturations up to 77%, porosity up to 22% and permeability up to 700 md. API-gravity is between 11 and 13. In order to fit the wellbore and reach the required depth, no standard waveguides were used. Instead of this, a specially designed coaxial cable with adapters for the microwave generator outlet was applied. A separate temperature sensor was placed downhole in order to measure the near-wellbore temperature. The complete coaxial tubing was dried and protected by replacing the air with nitrogen and applying adequate pressure. A generator-cooling system has been applied for the coaxial tubing. A down hole pump was integrated with a sufficient distance to the housing/shield of the RFEA. A 915-MHz generator has been used, taking into account a moderate water saturation in the formation at approx. 11-15%. After first applying up to 35 kW (constantly rising) on a continuous basis for 21 hours, the emitting has been stopped for 3 hours and after this the generator output power has been set at continuously below 10 kW, overall kWh/day were set at 200-240 kWh/day maximum. Optimum oscillation effect has been determined at this low power level in this particular case. The frequency modulation had to be simulated by adaptation, which meant finding the correlated output level to the applied frequency and the water content in the formation. Although not driven at optimum oscillation frequency, the API gravity has been changed on a permanent basis from as low as 11.4 API-gravity up to higher than 19 API-gravity, by adapting the correlated power to the properties of the crude oil samples before application. An increase in the output power level beyond 30 kW or higher led also to a substantial heating effect, but an increase in the permanent hydrocarbon cracking effect on the heavy crude oil could at a higher heating level in the near wellbore area beyond 210° C. not be observed. However, different crude oil properties might lead to the necessity of applying other frequencies at other output levels. This formation showed to be highly effective in the range of 915 MHz.

### B) Cracking and/or Demulsification of Hydrocarbon- and Fatty Acid-Emulsions in Treatment Tanks on Surface and Vessel-Tanks on Ships

### a) Treatment Tanks on Surface

Initially, hydrocarbon emulsions or fatty acid emulsions would be typically stored in the initial treatment tank (tank 1). The volume (capacity) of this tank should be preferably selected between 5,000 and 10,000 barrels, i.e. approx. 795,000 to 1,590,000 litres, but smaller and larger tanks may also be used, depending on the applied electromagnetic field (dependent on microwave frequency and output power and time exposure).

In this first tank, in the center, at least one microwave emitting system shall be installed, whereas a standard 915 MHz magnetron (or standard 896 MHz or 922 MHz), at 100 kW, can be used, but preferably a frequency modulation system should be applied, in order to change the frequencies from 400 MHz up to 1.5 GHz preferably, which can be achieved by reflex-klystron technology or broadband amplification systems. If a magnetron system is being applied, standard waveguides, adjusted to the magnetron frequency, can be used, in combination with a suitable Radio Frequency Emitter Antenna (RFEA), for instance the one that is described in the US patent US2011/0128203, but other RFEA's may work the same or better, as long as a homogenous emitting process is guaranteed, or, the emulsion can be also targeted directly within suitably designed waveguides, without even the need to apply an RFEA. If a frequency modulation system is being applied, the microwaves are best being emitted through a standard coaxial delivery system with a coaxial RFEA in the treatment tank. To accelerate the treatment process in the tank, and also reach improved results, the targeted emulsion in the tank should be rotated moderately.

Depending on the quality of the emulsion to be treated and the determined oscillation frequency of hydrocarbon chains or fatty acid chains in the emulsion, the generator should preferably be tunable to the correlated frequency and energy output for the purpose of cold cracking and a high efficiency of the demulsification process. As the system is a broadband system due to its adaptation ability by varying also the output power and the main cold cracking and demulsification catalyst, which in this case is mainly water, the system may also be tuned to be working with standard magnetrons at 896 MHz and/or 922 MHz and/or 915 MHz, whereas these frequencies may even be combined in the same tank by using two or more RFEA's. If using a frequency modulation system, the fine-tuning as to the oscillation frequency of the longer chained hydrocarbon or fatty acid molecular bonds is substantially easier and more efficient.

In this first tank, the frequency of the microwave generator shall be set at the correlated and matched frequency of the ex ante determined oscillation frequency of the longer chained hydrocarbon molecules or fatty acid molecules in the emulsion. This correlated frequency at the correctly adapted output power causes the targeted molecules to enter into the necessary and desired resonance frequency. At this frequency, even small periodic force or energy impacts can produce large amplitude oscillations, because the targeted molecular system stores vibrational energy. The power needed will usually be approximately between 40-100 kW for this first treatment tank, but depending on the volume and content of the emulsion to be treated, lower power can be applied as well. Less volume and longer hydrocarbon or fatty acid chains require less power output to reach the cold cracking and demulsification process, however, a certain minimum output power needs to be applied, as the desired electromagnetic effect according to this invention is a function of both frequency and output power. The cold cracking and demulsification process can be further improved as to broadband and efficiency, if suitable catalysts are being used. Both hydrocarbon and fatty acid emulsions will work more efficient if an adequate volume of for instance water or methanol is being introduced in the emulsion prior to the microwave treatment as described herein. But, more energy and more catalysts will be needed, the further away the microwave frequency will be from the oscillation frequency of the longer chained hydrocarbon molecules or fatty acid molecules in the emulsion. After reaching a certain discrepancy point between oscillation frequency of the longer chained hydrocarbon molecules or fatty acid molecules, there will be no cold cracking effect anymore, only the demulsification process might still show some effect, but with the price of higher energy need. In any case, the temperature of the emulsion always stays below the boiling point of water, thus it can be considered as a cold cracking process within the temperature range of approx. 55° C. to 90° C. and a cold demulsification process. In many cases of fatty acid treatments, the temperature of the targeted emulsion will not even go beyond approx. 60° C., only exceptionally up to approx. 75° C.

One treatment in one tank lasts approximately 5-10 hours. After this treatment, the separated and desired hydrocarbon or fatty acid product can be either re-processes in the same tank by pumping out the waste substrate or the separated and desired product can be pumped into another tank and re-treated based on the exact treatment as set out here before, this time with the adapted frequencies because of the cracked and thus now shorter hydrocarbon or fatty acid chains that now have also a different oscillation wave frequency. Furthermore, each after-treatment needs less microwave power output then the one before. For best results, the output power in the following treatments should be approximately lowered every time by 15-30%.

Some treatments arranged in a sequence (batch to batch process) lead to better results as to the efficiency rate of the cold cracking effect and the demulsification effect and thus also into a better “cleaning” effect. In addition, by using an arrangement of more tanks in a series, a continuous process (flow-through-process) can be maintained.

The cold cracking and/or demulsification and cleaning process of hydrocarbon- and fatty acid emulsions can be optimized, if the pre-processed hydrocarbon or fatty acid emulsion will be at last processed with a pulsing microwave system, that might use even lower power. Again, the frequency is being preferably adapted to and correlated with the hydrocarbon's or fatty acid's own molecular oscillation frequency in this last treatment tank. Depending on the molecular oscillation frequency of the targeted hydrocarbons or fatty acids, there might be a shift from the standard 915 MHz frequency to the higher standard 2.45 GHz with pulsing ability, as through the pre-processed hydrocarbon or fatty acid molecules the own oscillation frequency might change towards higher frequencies in the range closer to the standard frequency at 2.45 GHz, whereas the frequency range is not limited. However, a frequency modulation ability of this system combined with pulsing ability will again enable to reach a higher demulsification and/or cold cracking success rate at lower power consumption and less need to use catalysts to adapt a broadband microwave energy field.

In each of the tanks, a moderate rotation of the emulsion is of advantage during the treatment process. Furthermore, better results are being achieved if the hydrocarbon or fatty acid emulsion is being processed in a pressure tank (up to 5 bars pressure related to a approx. 30-40 m² tank). In case of the hydrocarbon emulsion, the usage of hydrogen injection during the treatment improves the quality of the treated crude oil. Gases that might evolve during the treatment shall be re-introduced into the emulsion by jetting them in the bottom of the treatment tank during the microwave treatment. A certain minimum amount of water content is of advantage for the treatment, such as approx. 10%-20% in the case of hydrocarbon emulsions, and 15%-30% in the case of fatty acid emulsions.

After pre-treatment of the fatty acid emulsion based on the here described invention, the fatty acid product can be post-treated again, preferably in a pressurized tank and by applying the same microwave emitting procedure, in order to reach an esterification of these fatty acids. During the microwave treatment, the fatty acids may thus also be combined with an adequate volume of methanol and other suitable catalysts, such as for instance sodium methoxide (NaNOCH₃), in order to produce fatty acid methyl ester (FAME). The advantage here is, that this treatment enables even for the post processing and thus organic synthesis of the pre-processed fatty acid emulsion, again on a non-thermal and thus low energy basis, which is a unique process.

### b) Oil Tankers/Vessels

A typical design of an oil tanker provides for several compartments where the crude oil petroleum/oil emulsion is stored. Several compartments are being used to improve the security in case of a disaster.

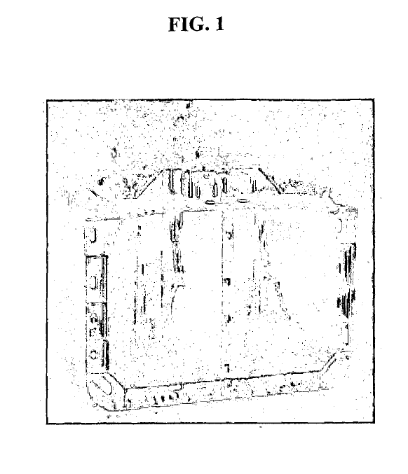

The design of an oil tanker in a cross-section looks as shown in FIG. 1.

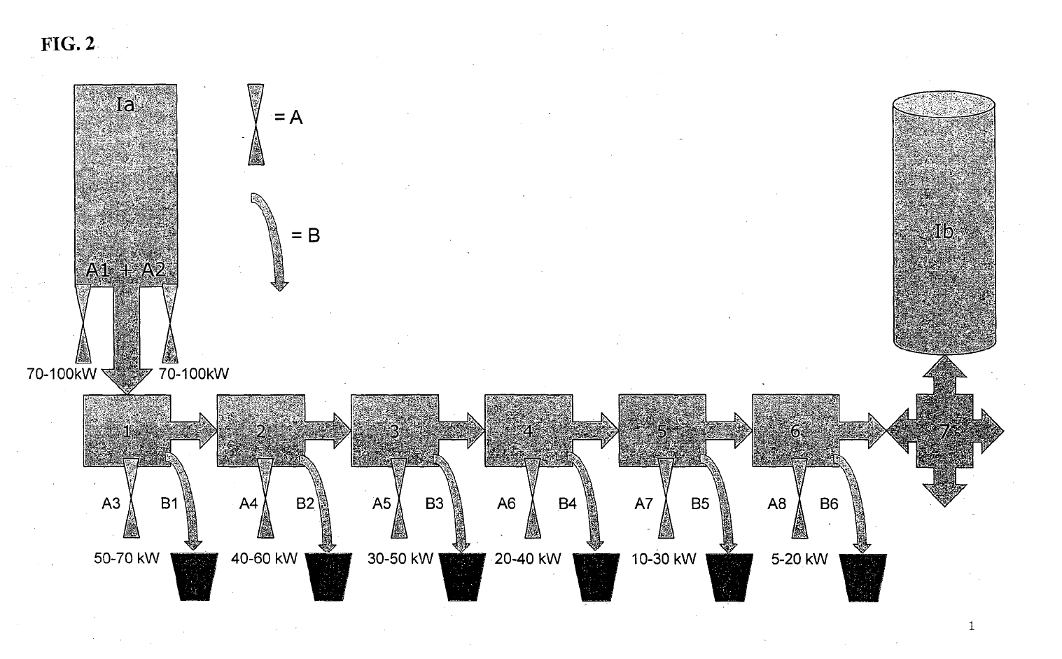

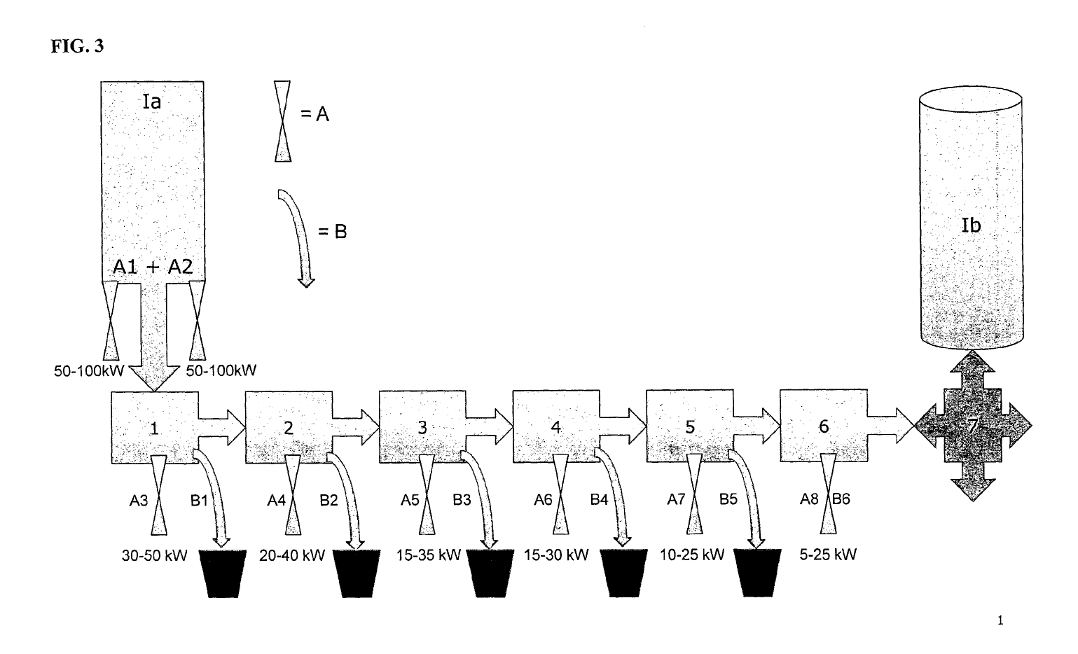

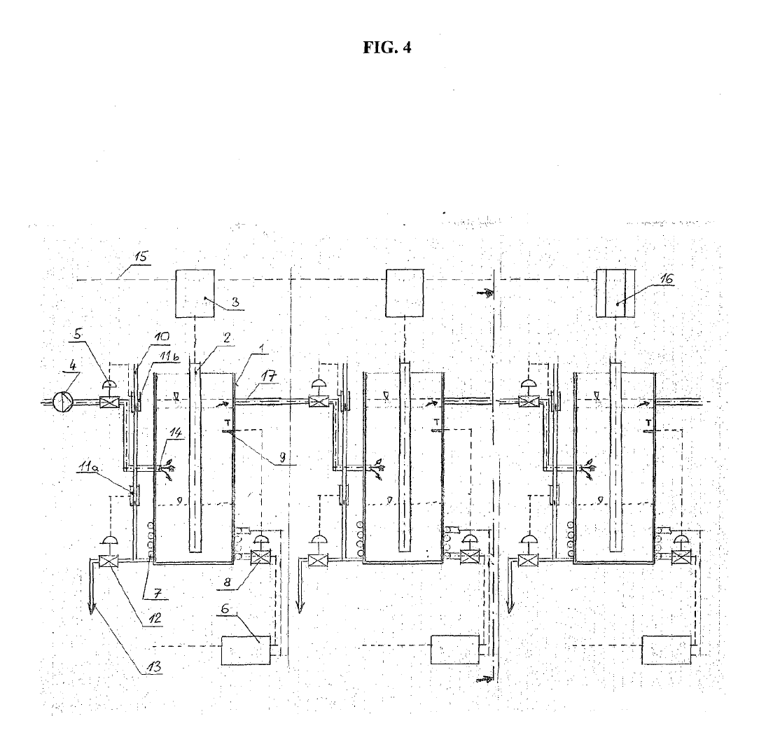

There are typically several of such compartments integrated in a modern oil tanker. The invention also provides for the solution to cold crack the hydrocarbons or fatty acids and to efficiently demulsify such emulsions while being transported in such compartments during the shipment time. In order to process the loaded crude oil or other oil and/or fatty acids on such tankers, there should be at least six compartments or more where the hydrocarbon or fatty acid emulsion can be pumped after having been treated in one compartment. The same procedure as set out here before shall be applied for each compartment. After the treatment is finished, the processed emulsion shall be pumped in the compartment where each generator is again set at the corresponding oscillation frequency of the hydrocarbons or fatty acids being treated at a specific time. Each compartment shall use again the correlated frequency of the emulsion and the same power output scheme as set out here before. In the last compartment, the emulsion shall be treated preferably with a low power pulsing generator. All compartments should be treated with suitable RFAS's as set out here before. The impurities drop out to the bottom of the respective compartments and can be pumped away into a separate waste compartment. The process can be also applied on vessels as described hereafter according to the ideal surface cold cracking and demulsification procedure and based on the process description scheme as per FIG. 2 or FIG. 3 in combination with FIG. 4.

To achieve better, i.e. more efficient and faster results, the emulsion is preferably being rotated in the tank during the treatment.

### C) Cracking and Demulsification of Hydrocarbon- and Fatty Acid-Emulsions in Flow-Through Processes on Surface, Such as Pipelines or Dedicated Flow-Through-Designs

### Example C1—the Flow Process with Super-Heavy Oil (not Flowing) as Shown in FIG. 2

In this example a non-flowing hydrocarbon emulsion and/or a non flowing fatty acid emulsion in the first tank Ia (crude oil or FFA) is shortly pre-treated (pre-heated) preferably with two (electromagnetic) emitters A1 and A2. A1 emitter is used for heating to make the emulsion flow in this process, while A2 emitter is used for a frequency modulation. In the same time impurities B such as sulfur, coke, paraffin, etc. are removed by separation and by preferably washing it out with water. The treatments occur in a serial row of preferably four to six compartments 1-6 marked by 1, 2, 3, 4, 5, 6 which are being connected to each other. Each compartment is equipped with a corresponding emitter A3, A4, A5, A6, A7 or A8. Compartments 1, 2 and 3 work as warm treatment compartments, whereas compartments 4, 5 and 6 work as cold treatment compartments. The last compartment 6 preferably works with a pulsing module. Again, the same approach needs to occur as described here before: The microwave frequency needs to be set and correlated to the frequency of the oscillation frequency of the targeted long chained hydrocarbon molecules or fatty acid molecules in each compartment I, 1, 2, 3, 4, 5, 6. The power output needs to be adjusted accordingly, as set out in the scheme here before, and, if standard magnetrons are being used, the system needs to be adjusted as to the broadband functionality by applying the adequate output power level in correlation with suitable catalysts. Such catalysts are water, and/or methanol and/or ethanol and or surfactants and/or hydrogen gas, whereas such catalyst are being preferably, but not necessarily, depending on the properties of the crude oil/FFA samples, also used if the frequency has been tuned in optimum to the oscillation frequency of the hydrocarbon or FFA molecules.

To achieve better, i.e. more efficient and faster results of the cold cracking and/or demulsification process, except as to the first tank Ia containing a non-flowing hydrocarbon and/or fatty acid emulsion, the emulsions are being preferably moderately rotated in each tank during the treatment process. Depending on the properties of the crude oil emulsion and/or FFA emulsion, a treatment can also occur only in the tank (compartment) Ia, if the results will be satisfactorily by only a shortened treatment. Depending on the properties of the crude oil emulsion and/or FFA emulsion, a treatment can also occur only in the tank (compartment) Ia, if the results will be satisfactorily by only a shortened treatment.

It is also preferable to add, in the first treatment tank (compartment) suitable crude oil surfactants or FFA surfactants to the emulsion for creating an optimum emulsion to be further pumped into succeeding treatment tanks (compartments).

Furthermore, in order to ensure an efficient flowing of the targeted emulsion relating to the non-flowing hydrocarbon/fatty acid emulsion, approx. 30 to 40% of the volume of the non-flowing hydrocarbon/fatty acid emulsion shall be conveniently added in the form of water, which furthermore also works as catalyst.

At the end the (pre-)treated product is led through pipe lines 7 to the consumer's truck tank or into cracking tower/refinery Ib.

### Example C2

The Flow-Through Process with Heavy to Semi-Heavy Oil (Flowing): is Shown in FIG. 3.

In this example, there is no thermal pre-treatment needed, as the crude oil emulsion and/or fatty acid emulsion is flowing at regular outside temperature. Nevertheless, a moderate heating of the emulsion to a temperature of about 40° C. may have a positive impact on the process efficiency. Along with the above described procedure, impurities B such as sulfur, coke, paraffin, etc. are removed by separation and by preferably washing it out with water. The treatments occur again in a serial row of preferably six compartments 1-6 marked by 1, 2, 3, 4, 5, 6 which are being connected to each other. Each compartment is equipped by corresponding emitter A3, A4, A5, A6, A7 or A8. Compartments 1, 2, 3 work as moderately warm treatment compartments, 4, 5, 6 work as cold treatment compartments. The last compartment 6 preferably works with a pulsing module. The treatment procedure as to the emitting of microwave frequency, output power and catalysts shall be applied as set out here before. Preferably, the microwave frequency is set at the correlated oscillation frequency of the longer chained hydrocarbon or fatty acid molecules in each treatment tank. The energy output should be, subject to the approximation of the microwave frequency to the optimum oscillation frequency, be set in a range as indicated above.

To achieve better, i.e. more efficient and faster results of the cold cracking and/or demulsification process, the emulsions are being preferably moderately rotated in each tank during the treatment process. Catalysis will preferably but not necessarily being used. Such catalysts are water, and/or methanol and/or ethanol and or surfactants and/or hydrogen gas, whereas such catalyst are being preferably, but not necessarily, depending on the properties of the crude oil/FFA samples, also used if the frequency has been tuned in optimum to the oscillation frequency of the hydrocarbon or FFA molecules. Depending on the properties of the crude oil emulsion and/or FFA emulsion, a treatment can also occur only in the tank (compartment) Ia, if the results will be satisfactorily by only a shortened treatment.

It is also preferable to add in the first treatment tank (compartment), suitable crude oil surfactants or FFA surfactants to the emulsion for creating an optimum emulsion to be further pumped into succeeding treatment tanks (compartments).

At the end the (pre-)treated product is led through pipe lines 7 to the consumer's truck tank or into cracking tower/refinery Ib.

### Example C3

The Cold Cracking and/or Demulsification Procedure for Flow-Through Processes with a Mechanism for the Drop Out of Undesired Substrate is Shown in FIG. 4.

What is important in this flow-through process in accordance with the invention as described herein, is that the emulsion should continuously moderately rotate in each tank in one direction, which increases the demulsification efficiency and separation of the substrate containing impurities and undesired compounds. However, this rotation is not mandatory in order to reach the cold cracking and/or demulsification effect. Depending on the composition of the emulsion/product during or after the here described microwave treatment, it may be of advantage to incorporate a regular tow-way or tri-canter centrifuge or in the treatment process, in order to separate the different phases and water and other impurities.

The system for this microwave treatment process consists of three to six treatment tanks 1, 1′, 1″, 1′″, 1″″, 1′″″ that are connected with each other through adequate tubing 17. A mixture of the hydrocarbon or fatty acid emulsion and the catalyst, such as water and/or methanol and/or ethanol and/or surfactants or other suitable catalysts, is filled into the first tank 1. The emulsion shall be pumped 5 in the tank 1 through a tubing that hat its inlet 14 at approx. half of the height of the treatment tank 1, so that the inflow 14 of the emulsion is creating a rotation of the emulsion in the treatment tank 1. If the inflow 14 of the emulsion with water is not sufficient in order to reach a moderate rotation of the emulsion in the tank, a small pump shall be added to ensure such a rotation of the emulsion. On the outer side of the bottom part of the tank, a heating unit 7 may be installed so that the temperature of the emulsion in the tank 1 is being maintained at about 40° C. at minimum using a temperature sensor 9 and a regulation valve heating 8, provided that the energy consumption for this heating source is smaller than if the here applied microwave system 2 would be used as the heating source. Inside the treatment tank 1, one or two RFEA's 2 are being installed, or only one coaxial RFEA 2 (magnetron or frequency modulation). By creating the adequate electromagnetic field as a function of frequency, output power and catalyst content, the hydrocarbon emulsion gradually becomes lighter in terms of gravity and its viscosity is being lowered, both on a permanent basis. Furthermore a large part of the impurities (sulfur, coke, paraffin) are being separated from the desired crude oil and will drop to the tank bottom, together with a large part of the separated water. A measuring system makes it possible to monitor the level of separated impurities and will ensure the removal if a certain trigger point is reached.

The use of two sources 3 of microwave energy (which are e.g. RFEA's) in each of the tank at the same time makes it possible to increase the production and efficiency rate of the targeted hydrocarbon emulsion and/or fatty acid emulsion or they allow for a more efficienty demulsification due to the use of different frequencies and different output levels.

When the first tank 1 is filled and partially treated, the desired product flows through outlet tubing under the top edge of the tank to the next treatment tank 1′ where it is subject to the same process again, but here taking into account the different property of the emulsion at hand (higher frequency, less power consumption, different catalytic approach). In this following treatment tank 1′, the already pre-treated emulsion will be further improved as to its quality parameters, if desired. The number of treatment tanks to be used is determined by the poor quality of the initial emulsion. The same multiple treatment effect may be achieved by using less tanks in a row, by potentially slowing down the pumping rate and thus expanding the microwave emitting treatment time.

In the last treatment tank 1′″″ (or parallel in the first treatment tank, if only one treatment tank is being used), a pulsing microwave system at the adequate frequency shall be used preferably after the standard microwave emitting treatment has occurred. The final product shall be further pumped into the transportation or storage tank. In this storage tank, the produced hydrocarbons or fatty acids might be preferably stored a few hours, so that an efficient separation of the molecularly pre-separated oil phase-water phase can be achieved, if appropriate. The produced waste product shall be pumped into separate waste storage tanks for re-processing or other purposes.

This treatment process in accordance with the herein described invention is preferably used for the treatment of heavy to semi-heavy crude oil or longer chained fatty acid molecules in heavier fatty acid emulsions. The shorter the hydrocarbon molecules or fatty acid molecules are, the more difficult it is to achieve a cold cracking effect based on the here described non-thermal approach. Further reference is made to the annexed drawings and its description.

Although this invention has been illustrated with the use of several applied examples, in the execution of this art various modifications and improvements can be expected in such way that these modifications will not exceed the scope of this invention.

The scope of the invention is not interpreted as being limited to the here described examples, but is defined according to the scope of the patent claims annexed hereto.

### LISTS OF REFERENCE SIGNS

### FIG. 2

### (Flow-Through-Design, Non-Flowing Emulsion)

A=Electromagnetic Emitter (RFEA)
B=Dropout of Impurities
Ia=Hot Pre-Treatment Compartment: Non-Flowing Hydrocarbon Emulsion/Non-Flowing Fatty Acid Emulsion
Ib=Cracking Tower (Crude)/Distillation Tower (FFA)—Optional
A1=Electromagnetic Emitter—Heating
A2=Electromagnetic Emitter—Frequency Modulation/Adaptation
A3-A7=Electromagnetic Emitter—Frequency Modulation/Adaptation
A8=Electromagnetic Emitter—Pulsing Frequency Modulation/Adaptation
1=Warm Treatment Compartment/Tank no. 1
2=Warm Treatment Compartment/Tank no. 2
3=Warm Treatment Compartment/Tank no. 3
4=Cold Treatment Compartment/Tank no. 4
5=Cold Treatment Compartment/Tank no. 5
6=Cold Treatment Compartment/Tank no. 6 with pulsing module
7=Pipeline into Cracking Tower/Refinery or Truck Tank
B1-B6=Dropout of Impurities into Waste Compartment/Waste Tank

### FIG. 3

### (Flow-Through-Design, Flowing Emulsion)

A=Electromagnetic Emitter (RFEA)
B=Dropout of Impurities
Ia=Warm Pre-Treatment Tank with Flowing Hydrocarbon Emulsion/Flowing Fatty Acid Emulsion
Ib=Cracking Tower (Crude)/Distillation Tower (FFA)—Optional
A1=Electromagnetic Emitter—Warming
A2=Electromagnetic Emitter—Frequency Modulation/Adaptation
A3-A7=Electromagnetic Emitter—Frequency Modulation/Adaptation
A8=Electromagnetic Emitter—Pulsing Frequency Modulation/Adaptation
1=Cold/Warm Treatment Compartment/Tank no. 1
2=Cold/Warm Treatment Compartment/Tank no. 2
3=Cold Treatment Compartment/Tank no. 3
4=Cold Treatment Compartment/Tank no. 4
5=Cold Treatment Compartment/Tank no. 5
6=Cold Treatment Compartment/Tank no. 6 with pulsing module
7=Pipeline into Cracking Tower/Refinery or Truck Tank
B1-B6=Dropout of Impurities into Waste Compartment/Waste Tank

### FIG. 4

1, 1′, 1″ . . . 1′″″ treatment tank(s)
2 microwave antenna (RFEA)
3 microwave generator
4 pump for chemicals/emulsion
5 regulation valve for chemical compounds/emulsions
6 water heating source
7 heating coil
8 regulation valve heating
9 temperature sensor
10 syphon tubing
11 sensor as to emulsion levels of a) drop outs/waste, b) components/air
12 regulation valve for dumping of drop outs/waste
13 drop outs/waste disposal tubing
14 discharge nozzle for chemical compounds/emulsions
15 electric line to feed microwave generator
16 pulsing microwave generator system
17 outlet tubing for treated emulsions

1. A method of cracking and/or demulsification of hydrocarbons and/or fatty acids in emulsions characterized in that these hydrocarbons and/or fatty acids in emulsions are being exposed town electromagnetic field by emitting microwaves that are correlated with the oscillation frequency of the targeted molecules of these hydrocarbons and/or fatty acids.

2. The method in accordance with claim 1, characterized in that the emulsion of hydrocarbons and/or fatty acids consists of emulsions of the water-in-oil (W/O), oil in water (O/W) or water-in-oil-in-water (W/O/W) types.

3. The method in accordance with claim 1 or 2, characterized in that the method is executed in a formation (pay zone) below surface or on surface outside of a formation.

4. The method in accordance with claims 1 to 3, characterized in that it comprises the following consecutive steps:
a) determining the oscillation frequency of the targeted molecules of the hydrocarbons and/or fatty acids in the emulsion using well-known methods, comprising the use of oscilloscopes or spectrometry or calculation, to adjust the electromagnetic field so that the microwaves correlate with the determined oscillation frequency;
b) correlating and equalizing the microwave energy with the determined hydrocarbon and or/fatty acid molecule oscillation frequencies, by using a specific frequency as a function of the output power and/or by using catalysts;
c) applying microwave energy in correlation with the oscillation frequency of the targeted molecules of the hydrocarbons and/or fatty acids in at least one step and
d) optionally applying microwave energy in a pulsing mode on the targeted molecules of the hydrocarbons and/or fatty acids.

5. The method in accordance with claims 1 to 4, characterized in that the emitting of microwave energy as set out in steps 4c) to 4d) to liquid emulsions are carried out at ambient temperatures below the boiling point of water.

6. The method in accordance with claims 1 to 4, characterized in that the steps of application of microwave energy in steps 4c) to 4d) to non-flowing emulsions at room temperature are carried out at a combination of an elevated temperature and succeeding ambient temperature, below the boiling point of water.

7. The method in accordance with claim 6, characterized in that before the steps of application microwave energy as set out in steps 4c) to 4d) the emulsions are moderately heated up to reach the flowing point, with at least one conventional heat source and by ideally further emulsifying this initial emulsion in the first treatment tank (compartment) by adding water in order to reach a 30% to 40% water content of the initial emulsions and by ideally adding suitable crude oil surfactants or other emulsifiers to the emulsions in the first treatment tank.

8. The method in accordance with claims 1 to 7, characterized in that in accordance with steps 4b) to 4d) microwave energy is correlated with the oscillation frequency of the longer chained molecules of hydrocarbons and/or fatty acids.

9. The method in accordance with claim 4, characterized in that microwave energy in accordance with step 4c)—is applied in the range of approx. 10 kW to approx. 100 kW either with standard magnetrons in the frequency range of 896 MHz to 922 MHz, or, with a frequency modulation system in the frequency range of 400 MHz to 1.5 GHz, but not limited to this frequency range, causing the cracking of the longer chained molecules of hydrocarbons and/or fatty acids and/or the demulsification, i.e. separation of impurities as e.g. sand, metallic particles, sulfur, coke, organic substances, water etc. from the hydrocarbons and/or fatty acids.

10. The method in accordance with claims 3 to 9, characterized in that in the case of hydrocarbon extraction in a formation (pay zone) below surface microwave energy in accordance with step 4c) and optionally step 4d) is emitted through periodically interrupted action for the period of at least 2 to 3 weeks, with the energy value from approx. 70 kW to approx. 100 kW with a correlation of the emitting frequency with the oscillation frequency of the molecules of the hydrocarbon, which leads to a cracking of the longer chained hydrocarbons, i.e. reduction of the length of their molecular chain and consequently reduction of their specific gravity and viscosity, on a permanent basis.

11. The method in accordance with claims 3 to 9, characterized in that when microwave energy is emitted to hydrocarbon and/or fatty acid emulsions on surface, after step 4c) at least another step of microwave energy emitting is included, either with standard magnetrons in the frequency range of 896 MHz to 922 MHz, or, with a frequency modulation system in the frequency range of 400 MHz to 1.5 GHz, but not limited to this frequency range, applying a lower microwave energy level that shall be conveniently reduced by approx. 15% to 30% in the succeeding treatment process, and by applying a re-correlated electromagnetic field as set out in step 4c).

12. The method in accordance with claim 11, characterized in that the microwave energy emitting procedure on surface (outside a formation below surface) is carried out in dedicated treatment tanks, vessel compartments, especially oil tankers, or in pipelines or in flow through systems.

13. The method in accordance with claim 12, characterized in that the hydrocarbon or fatty acid emulsion is being exposed to the microwave treatment as set out in 4b) to 4d) in treatment tanks, with a tank volume of approx. 5,000 to 10,000 barrels, i.e. approx. 795,000 to 1,590,000 litres, by emitting the microwave energy in the range of approx. 40 kW to approx. 100 kW either with standard magnetrons in the frequency range of 896 MHz to 922 MHz, or, with a frequency modulation system in the frequency range of 400 MHz to 1.5 GHz, but not limited to this frequency range, whereas the first treatment takes approx. 5 to 10 hours and whereas subsequently the product is either stored in dedicated storage tanks or whereas, after the separation of impurities, it is preferably treated again in a succeeding treatment tank by correlating the microwave energy to the now changed properties of the targeted longer chained hydrocarbon or fatty acid molecules, addressing the now shorter molecular chains of the hydrocarbon or fatty acid molecules after the successful previous treatment, in order to further crack and/or further demulsify the existing hydrocarbon or fatty acid molecules in the emulsion.

14. The method in accordance with claim 13, characterized in that the hydrocarbons and/or fatty acids or their emulsions are, in the last treatment procedure, or after or simultaneously with the first treatment procedure, exposed to pulsing microwave energy with the electromagnetic field being correlated with the oscillation frequency of the molecules of the hydrocarbon and/or fatty acid, either with standard magnetrons in the frequency range of 896 MHz to 922 MHz or 2.45 GHz, or, with a frequency modulation system in the frequency range of 400 MHz up to 2.5 GHz, but not limited to this frequency range.

15. The method in accordance with any of the claims 12 to 14, characterized in that during the hydrocarbon and/or fatty acid emulsion is being processed by means of microwave energy, the emulsion shall be moderately rotated inside the treatment tank, preferably around the electromagnetic source of the emission in the treatment tank.

16. The method in accordance with any of claims 12 to 15, characterized in that in one treatment tank, depending on the particular properties of the hydrocarbon or fatty acid emulsion, and depending on the particular radiation angle of the electromagnetic source, preferably two electromagnetic sources (RFEA's) are being applied simultaneously and with different electromagnetic field properties, thus addressing different molecular properties of the targeted hydrocarbons and/or fatty acids.

17. The method in accordance with claim 12, characterized in that the hydrocarbon and/or fatty acid emulsions are exposed to microwave energy for the purpose of cracking of the hydrocarbon and/or fatty acid molecules and/or for the purpose of demulsification of the hydrocarbon and/or fatty acid emulsions, with the electromagnetic field adequately correlated with the oscillation frequency of the molecules of the targeted hydrocarbon and/or fatty acid molecules in at least one treatment compartment, comprising that of a vessel/oil tanker, and whereas the treated emulsion may be kept in the initial treatment compartment or is subsequently pumped ideally in different succeeding compartments where the cracked/demulsified product may be either stored as the final product or where in each of the succeeding compartments the pre-treated emulsion/product may be further treated by exposing it to a now re-correlated electromagnetic field by using the microwave emitting procedure according to 4a) to 4d), such correlation to occur according to the properties of the changed molecular structure of the longer chained hydrocarbon and/or fatty acid molecules.

18. The method in accordance with claim 17, characterized in that the hydrocarbons and/or fatty acids or their emulsions are in the last treatment procedure, or after or simultaneously with the first treatment procedure, exposed to pulsing microwave energy with the electromagnetic field being correlated with the oscillation frequency of the molecules of the hydrocarbon and/or fatty acid, either with standard magnetrons in the frequency range of 896 MHz to 922 MHz or 2.45 GHz, or, with a frequency modulation system in the frequency range of 400 MHz up to 2.5 GHz, but not limited to this frequency range, with in the range of energy values of 5-20 kW.

19. The method in accordance with claim 12, characterized in that relating to the hydrocarbon and/or fatty acid emulsions in a non-flowing emulsion at room temperature as e.g. super-heavy oil in a through-flow system, approx. 30% to 40% of the volume of the at room temperature non-flowing hydrocarbon/fatty acid emulsion shall be in the form of water, and thus the proper volume of water is conveniently added to the hydrocarbon and/or fatty acid emulsion for an efficient flow and emulsification of the before non-flowing hydrocarbon/fatty acid emulsions, and then are first exposed to either a conventional heat source or exposed to the microwave emitting procedure in a way, so the initially non-flowing emulsion starts to flow, supported in this first tank preferably by adding suitable crude oil/FFA surfactants or other emulsifiers, and the flow-through process can be executed, whereas the hydrocarbon and/or fatty acid emulsions are, after this initial flowing and emulsification procedure, being exposed to the electromagnetic field in each compartment in correlation with the oscillation frequency of the specifically therein targeted hydrocarbon and/or fatty acid molecules/emulsions, according to 4a) to 4d), whereas in each succeeding treatment procedure, supported preferably by adding suitable catalysts to the emulsions, a lower energy level of microwave energy is being applied in comparison with the previous treatment procedure, e.g. 50-70 kW, 40-60 kW, 30-50 kW, 20-40 kW and 10-30 kW.

20. The method in accordance with claim 19, characterized in that the hydrocarbons and/or fatty acids or their emulsions are, in the last treatment procedure, or after or simultaneously with the first treatment procedure, exposed to pulsing microwave energy with the electromagnetic field being correlated with the oscillation frequency of the molecules of the hydrocarbon and/or fatty acid, either with standard magnetrons in the frequency range of 896 MHz to 922 MHz or 2.45 GHz, or, with a frequency modulation system in the frequency range of 400 MHz up to 2.5 GHz, but not limited to this frequency range, within the range of energy values of 5-20 kW.

21. The method in accordance with claim 12, characterized in that the hydrocarbons and/or fatty acids in a flowing emulsion at surrounding temperature are exposed to the microwave emitting procedure according to 4a) to 4d), whereas the hydrocarbon or fatty acid emulsion is being exposed to the electromagnetic field in each compartment in correlation with the oscillation frequency of the specifically therein targeted hydrocarbon and/or fatty acid molecules/emulsions, according to 4a) to 4d), whereas in each succeeding treatment procedure a lower energy level of microwave energy is being applied in comparison with the previous treatment procedure, e.g. 50-70 kW, 40-60 kW, 30-50 kW, 20-40 kW and 10-30 kW.

22. The method in accordance with claim 21, characterized in that the hydrocarbons and/or fatty acids or their emulsions are, in the last treatment procedure, or after or simultaneously with the first treatment procedure, exposed to pulsing microwave energy with the electromagnetic field being correlated with the oscillation frequency of the molecules of the hydrocarbon and/or fatty acid, either with standard magnetrons in the frequency range of 896 MHz to 922 MHz or 2.45 GHz, or, with a frequency modulation system in the frequency range of 400 MHz up to 2.5 GHz, but not limited to this frequency range, within the range of energy values of 5-20 kW.
